(19) United States
(12) Patent Application Publication
(10) Pub. No.: US 2017/0096858 A1
(43) Pub. Date: Apr. 6, 2017

(54) MAGNET AND SENSOR CAP OF A ROTATIONAL CONTROL DEVICE

(71) Applicant: Halliburton Energy Services, Inc., Houston, TX (US)

(72) Inventors: Travis David Watters, Flower Mound, TX (US); Joseph Michael Karigan, Carrollton, TX (US)

(73) Assignee: Haliburton Energy Services, Inc., Houston, TX (US)

(21) Appl. No.: 15/314,821

(22) PCT Filed: Sep. 8, 2015
(86) PCT No.: PCT/US2015/048984

§ 371 Date: Nov. 29, 2016

Related U.S. Application Data
(60) Provisional application No. 62/049,041, filed on Sep. 11, 2014.

(51) Int. Cl. E21B 4/00; G01D 5/14; E21B 12/00

(52) U.S. Cl. CPC E21B 4/003; E21B 12/00; G01D 5/14

(57) ABSTRACT

A rotating control device (RCD) sensor assembly is provided. The rotating control device sensor assembly includes an emitter disposed on a rotational component of a rotating control device, wherein the emitter emanates a detectable signal field, a cap coupled to the rotational component to form a volume between the cap and the rotational component, wherein the emitter is enclosed within the volume, and wherein the cap is made of a transmissive material, and a sensor that detects the signal field through the cap as the emitter passes within a proximity of the sensor.

### BACKGROUND

1. Technical Field

The present disclosure relates to oil and gas exploration and production, and more particularly to a rotating control device (RCD) sensor assembly that includes an emitter and a sensor placed in a rotating control device.

2. Description of Related Art

Wells are drilled using a drill string to access and produce oil, gas, minerals, and other naturally-occurring deposits from subterranean geological formations. A rotating control device can be used in a variety of oil and gas operations including drilling operations in conjunction with the drill string. For example, a rotating control device may be used for a variety of applications including annular fluid containment and pressure management in onshore and offshore drilling environments. Rotating control devices provide annular fluid containment and pressure management by creating a pressure-tight barrier in a wellbore annulus that enables safe fluid containment and diversion creating a closed-loop drilling environment.

The rotating control device can include an outer stationary component and a rotational component. The rotational component rotates within the outer stationary component and may form a sealed interface with a rotating tool string that runs through the rotating control device. For example, the rotational component can include an inner rotating bearing assembly and an upper stripper that rotates along with a drill string during drilling operations while maintaining the pressure-tight barrier.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1A is a schematic view of an onshore well in which a rotating control device (RCD) that includes a sensor assembly is deployed;

FIG. 1B is a schematic view of an offshore well in which a rotating control device that includes a sensor assembly is deployed;

FIG. 2 is a schematic, cross-section view of an illustrative embodiment of a rotating control device that includes a stationary outer component with an integrated sensor and a rotational component with an integrated emitter;

FIG. 3 is a schematic, section view of the upper portion of the rotating control device from FIG. 2 that includes the stationary outer component with the integrated sensor and the rotational component with the integrated emitter;

FIG. 3A is a detail view of a portion of the rotating control device, as referenced in FIG. 3, including an emitter covered by a cap disposed in a rotational component and a sensor covered by a sensor cap disposed in an outer stationary component; and

FIG. 4 is a schematic, perspective view of a portion of the rotating control device of FIG. 2 that includes the integrated sensor and emitter.

### DETAILED DESCRIPTION OF ILLUSTRATIVE EMBODIMENTS

In the following detailed description of the illustrative embodiments, reference is made to the accompanying drawings that form a part thereof and is provided to assist the reader in gaining a comprehensive understanding of the methods, apparatuses, and/or systems described herein. These embodiments are described in sufficient detail to enable those skilled in the art to practice the invention, and it is understood that other embodiments may be utilized and that logical structural, mechanical, electrical, and chemical changes may be made without departing from the spirit or scope of the invention. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order.

To avoid detail not necessary to enable those skilled in the art to practice the embodiments described herein, the description may omit certain information known to those skilled in the art. Also, the respective descriptions of well known functions and constructions may be omitted for increased clarity and conciseness. The following detailed description is, therefore, not to be taken in a limiting sense, and the scope of the illustrative embodiments is defined only by the appended claims.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion and thus should be interpreted to mean “including, but not limited to.” Unless otherwise indicated, as used throughout this document, “or” does not require mutual exclusivity.

A rotating control device (RCD) may be used to contain annular fluids during drilling operations in which a rotating tool is deployed at the head of a well. The rotating control device can be located adjacent to a blow-out preventer, for example, and may be used to divert a drilling fluid or other wellbore fluid from a wellbore to another location. Examples of drilling operations that a rotating control device can be used with include, but are not limited to, managed pressure drilling (MPD), underbalanced drilling (UBD), and air drilling (AD).

The present disclosure relates generally to an emitter and sensor that may be used to determine the health of a rotational component of a rotating control device by, for example, counting the number of revolutions experienced by a rotational component of the rotating control device. The rotational component may be, for example, a rotating bearing assembly. The count may be compared to an expected lifespan to determine an estimate of the remaining lifespan of the rotational component, or a bearing or other wear component thereof

The present disclosure relates more particularly to a rotating control device sensor assembly that includes paramagnetic caps. The paramagnetic caps may serve as protective coverings for the emitter and sensor to isolate the emitter and sensor from fluids and debris without interfering with the sensor's ability to detect the emitter. The emitter may be a magnet or other device that emits a sensor-detectable signal in the form of a magnetic field, a broadcast electromagnetic wave, a reflected electromagnetic wave, an optical pattern, a sound wave, and/or other suitable signal transmissions. The caps that cover the emitter and/or sensor are made from a transmissive material selected such that the caps allow the transmission of the signal from the emitter to pass through and toward the sensor. For example, the caps may be magnetically transmissive, or paramagnetic, and therefore allow for a magnetic field of a magnetic emitter, such as a magnet, to emanate without material degradation. This configuration facilitates propagation of the magnetic field from the magnet toward the sensor, which is configured to detect the magnetic field. This configuration also prevents degradation of the magnet over time from fluids that may contain demagnetizing particulate. The sensor is selected to correspond to the emitter (by signal type), and may be an inductive sensor, a radio frequency sensor, an optical sensor, an acoustic sensor, or another wireless sensor that detects some form of field transmission from a corresponding emitter.

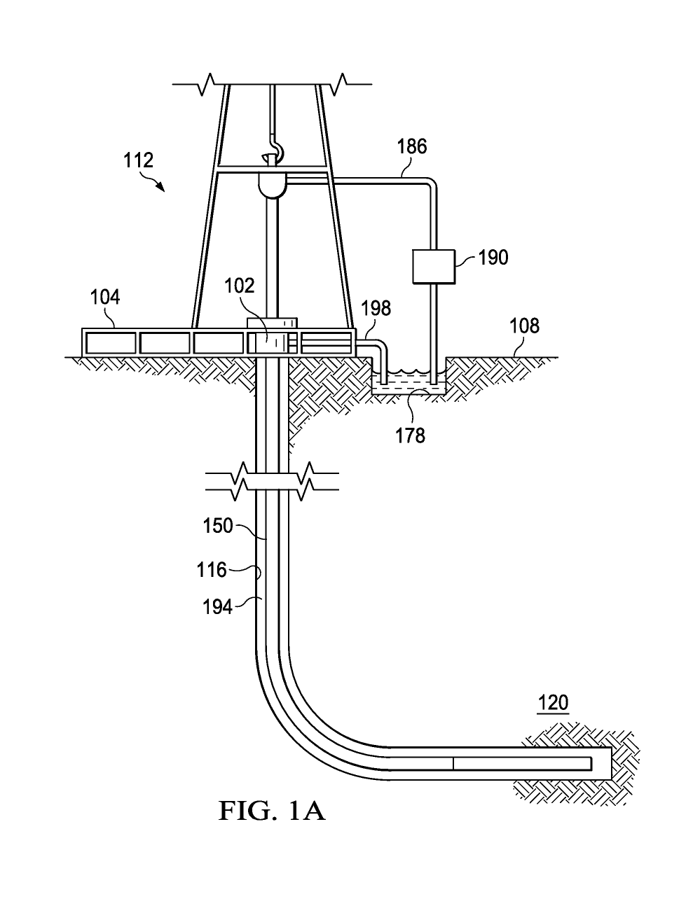

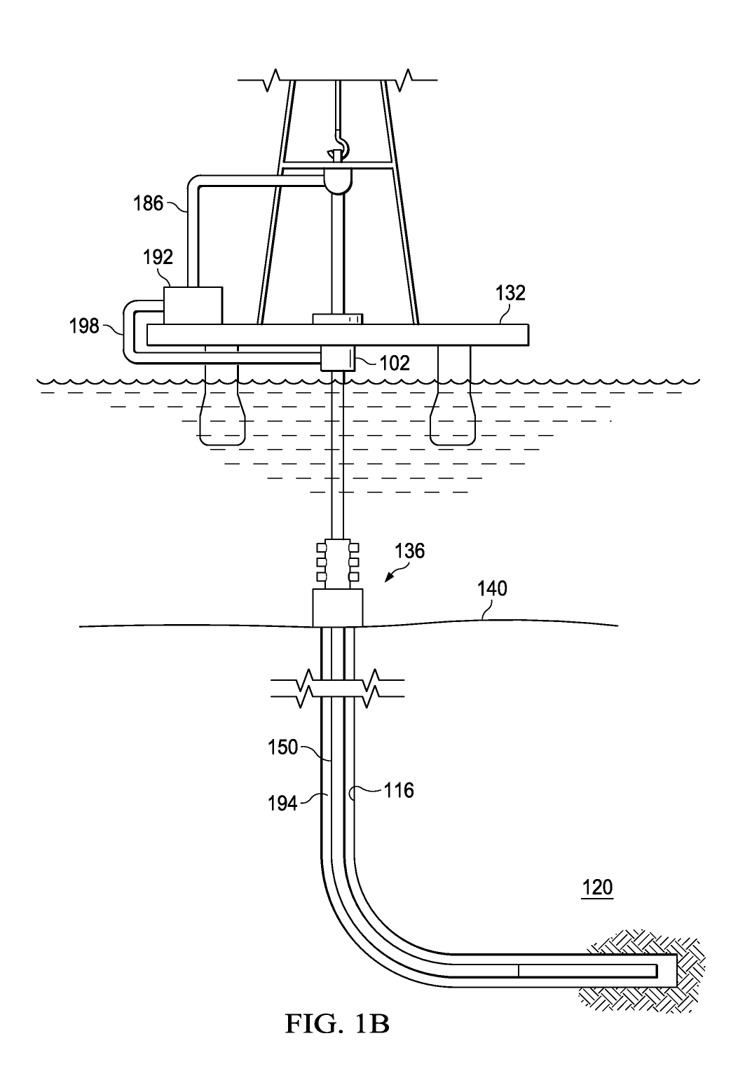

Turning now to the figures, FIG. 1A illustrates a schematic view of a rig 104 operating a rotating control device 102 that diverts a fluid traveling through an annulus 194 according to an illustrative embodiment. Rig 104 is positioned at a surface 108 of a well 112. The well 112 includes a wellbore 116 that extends from the surface 108 of the well 112 to a subterranean formation 120. The well 112 and rig 104 are illustrated onshore in FIG. 1A.

FIG. 1B illustrates a schematic view of an offshore platform 132 operating a rotating control device 102 according to an illustrative embodiment. The rotating control device 102 in

FIG. 1B may be deployed at a proximal end of a sub-sea well 136 above a blowout preventer accessed by the offshore platform 132. The offshore platform 132 may be a floating platform or may instead be anchored to a seabed 140.

FIGS. 1A-1B each illustrate possible uses or deployments of the rotating control device 102, and while the following description of the rotating control device 102 primarily focuses on the use of the rotating control device 102 during the drilling, completion, and production stages, the rotating control device 102 also may be used in other stages of well formation and operation where it may be desired to provide annular fluid containment, diversion, and pressure management.

In the embodiments illustrated in FIG. 1A and 1B, a wellbore 116 is formed by a drilling process in which dirt, rock, and other subterranean material is removed to create the wellbore 116. During or after the drilling process, a portion of the wellbore 116 may be lined with a casing (not illustrated in FIGS. 1A and 1B). In other embodiments, the wellbore 116 may be maintained in an open-hole configuration without a casing, or in a partially cased configuration.

To form the wellbore 116, a drill string 150 is operated to remove material from the subterranean formation 120. Drilling fluid travels down through the drill string 150 and returns through the annulus 194, reaching the rotating control device 102. The rotating control device 102 contains the drilling fluid and diverts the drilling fluid into a return line 198 which is part of a closed-loop fluid circulation system that includes rotating control device 102 and the return line 198 that feeds into a reservoir 178. A pump 190 pulls fluid from the reservoir 178 into a supply line 186. The supply line 186 provides fluid back to the drill string 150 and through the rotating control device 102 to again be used downhole during drilling.

The closed-loop fluid circulation system is shown in FIG. 1B as including the rotating control device 102 connected to the return line 198 that feeds into a pump and reservoir 192. The pump and reservoir 192 pass the fluid through supply line 186, which recirculates fluid back into the drill string 150.

During drilling, a rotational rate of the drill string 150 may vary. To facilitate rotation of the drill string 150 in a pressurized drilling environment, the rotating control device 102 may include an outer stationary component (which may be referred to as a pressure shell) and a rotational component that rotates along with the drill string 150. The number of rotations experienced by the rotational component may be monitored by the rotating control device 102. The sensors may be placed in and/or around the rotating control device 102 and the drill string 150 to collect operational information, such as rotation count and frequency that can be analyzed to monitor equipment health.

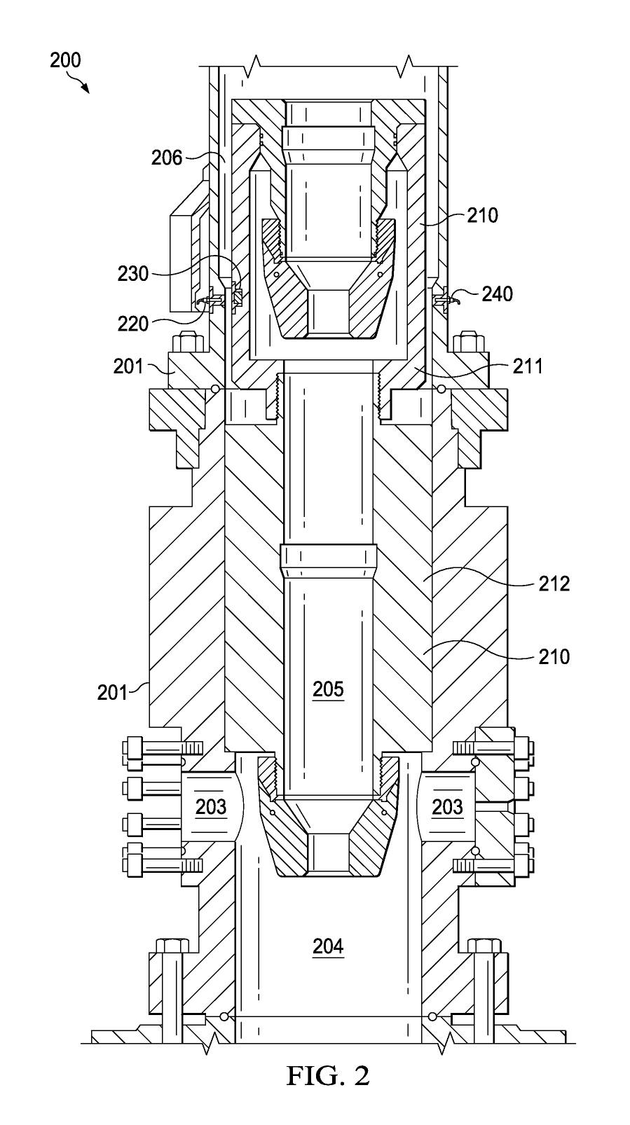

Referring now to FIGS. 2, 3, 3A, and 4, an illustrative embodiment of a rotating control device 200 is shown that includes an outer stationary component 201 with an integrated sensor 220 and a rotational component 210 with an integrated emitter 230. The outer stationary component 201 includes a through bore 204 that extends through the outer stationary component 201. The outer stationary component 201 may be referred to as a pressure shell, as noted previously. The rotational component 210 may be made up of an inner rotating bearing assembly 212 and an upper stripper 211. In other embodiments, the rotational component 210 may be any rotating sub-assembly within the outer stationary portion of the rotating control device. The rotational component 210 is positioned within the through bore 204 of the outer stationary component 201 and includes an inner annulus 205 through which a drill string or work string can run into or out of a wellbore. As shown, the integrated emitter 230 is included within an outer surface of the rotational component 210 that is adjacent to an annulus 206 between an inner surface of the outer stationary component and the outer surface of the rotational component 210. The emitter 230 can be located in a tubing string, the rotating control device body, the upper stripper, or the bearing assembly. The rotating control device 200 also includes fluid outlets 203 for diverting wellbore fluid to, for example, a return line and reservoir, as described previously.

The sensor 220 is included within the inner surface of the outer stationary component 201, adjacent to the annulus 206 and facing the emitter 230. The sensor 220 may be placed at the same longitudinal position as the emitter 230 such that the position of the sensor 220 is aligned with a rotational path of the emitter 230. In an embodiment, a second sensor 240 may be included in a position similar to that of sensor 220.

As shown in FIG. 2, the outer surface of the rotational component 210 and the inner surface of the outer stationary component 201 form a sealed interface. Additionally, the rotational component 210 is configured to provide a seal against the drill or work string that is run through the rotational component 210.

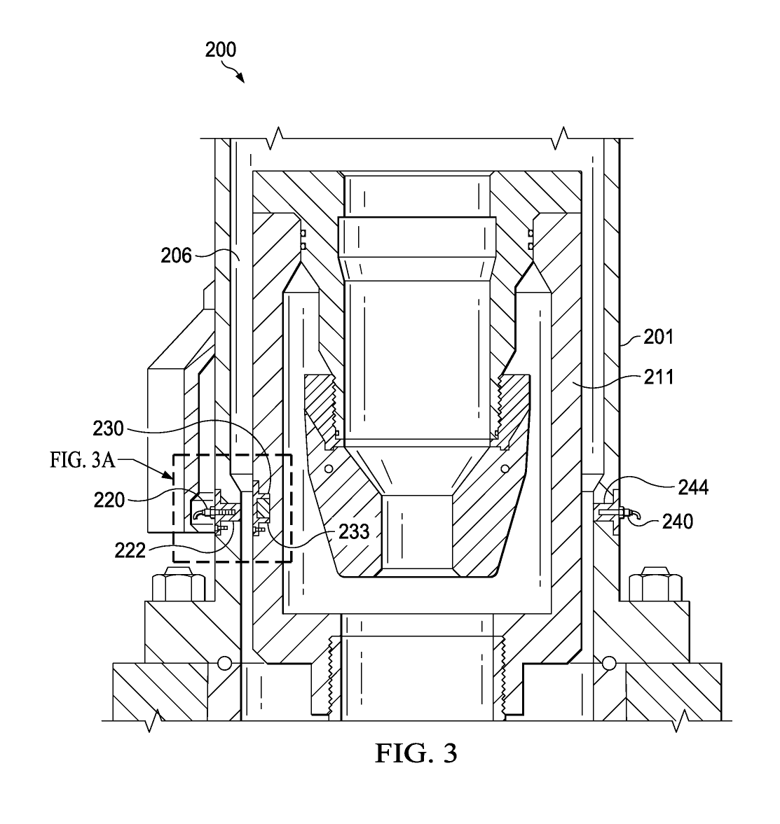

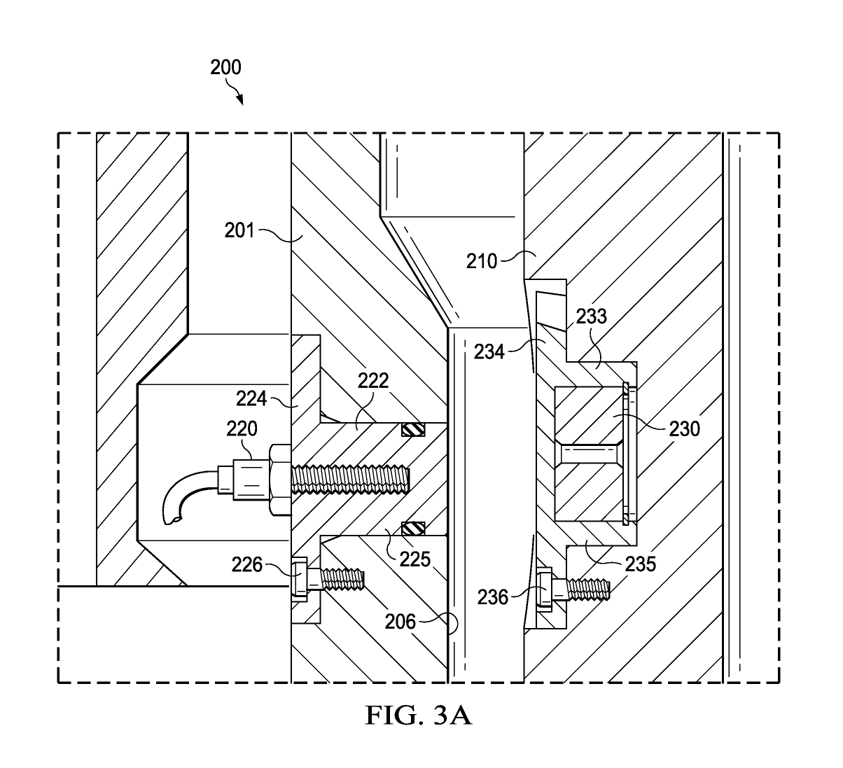

While the rotating control device 200 is generally sealed to prevent fluid from escaping the through bore 204 into the annulus 206, a small amount of fluid may penetrate the rotational component 210, and other fluid may be present in the annulus 206 to function as a lubricant and/or as a coolant. The upper portion of the rotating control device 200 is shown in more detail in FIG. 3, illustrating that the emitter 230 is included within the outer surface of the upper stripper 211. The sensor 220 is arranged to detect the presence of the emitter 230 and positioned directly across the annulus 206 from the emitter 230. While a single emitter and sensor arrangement is shown, it is noted that the rotational component 210 may include a plurality of emitters, and that the outer stationary component 201 may include a plurality of complementary sensors.

The detail view of FIG. 3A shows the emitter 230 within a cavity formed in the outer surface of the upper stripper 211. Additionally, the emitter 230 is enclosed by a cap 233. The cap 233 fits over the cavity, creating a volume within which the emitter 230 is positioned. An outward facing surface of the cap 233 is flush with or inset relative to the outer surface of the rotational component 210. In accordance with one or more embodiments, the cap 233 may wholly or partially surround the emitter 230. The cap 233 is positioned between the emitter 230 and the sensor 220, and may be made of a material that does not substantially decrease or diminish the strength of an emitter signal. Accordingly, the cap 233 can function to protect the emitter 230 from materials that would otherwise degrade or diminish the magnitude of the emitter signal at the sensor 220. According to an embodiment, the cap 233 may be fluidly sealed so that the emitter 230 will not come in contact with fluids in the annulus 206.

In an embodiment, the emitter 230 can be a magnet that emits a magnetic field. In such an embodiment, the cap 233 is made from a paramagnetic material through which the magnetic field of the magnet emanates without shielding effects such as field absorption or attenuation. The cap 233 may be made from austenitic stainless steel such as 316 stainless. According to other embodiments, the paramagnetic material that may be used for the cap 233 may include one or more of a nylon polymer, an austenitic nickel-chromium based super alloy (for example, Inconel), other austenitic stainless steels, plastic, and any combination thereof

Analogous to cap 233, the sensor 220 may be enclosed by a sensor cap 222 that forms an area around the sensor 220. In some embodiments, an outward facing surface of the sensor cap 222 is flush with the inner surface of the outer stationary component 201, and the area around the sensor 220 may be sealed. The sensor cap 222 may be made from the same material as the cap 233 or a suitable material having similar transmissive or paramagnetic properties. In an embodiment that includes a second sensor 240, the second sensor 240 may be protected by a second sensor cap 244 made of similar materials.

As shown in FIG. 3A, the shape of the cap 233 may include a cylindrical body 235 with an internal cavity that partially or completely surrounds an emitter 230. The outer surface of the cap 233 may extend beyond the cylindrical body to form a circular flange 234, which may provide a mounting surface through which the cap 233 may be fastened to the rotational component 210. The cap 233 may be coupled to the rotational component 210 using one or more screws 236 or other fasteners. Similar to the cap 233, the shape of the sensor cap 222 includes a cylindrical body 225 with an internal cavity that surrounds or encloses the sensor 220 and positions the sensor 220 proximate the axial location of the emitter 230. The sensor cap 222 may also have a disc-like, circular flange 224 that extends out from the cylindrical body.

The sensor cap 222 may be coupled to the outer stationary component 201 using one or more screw fasteners 226.

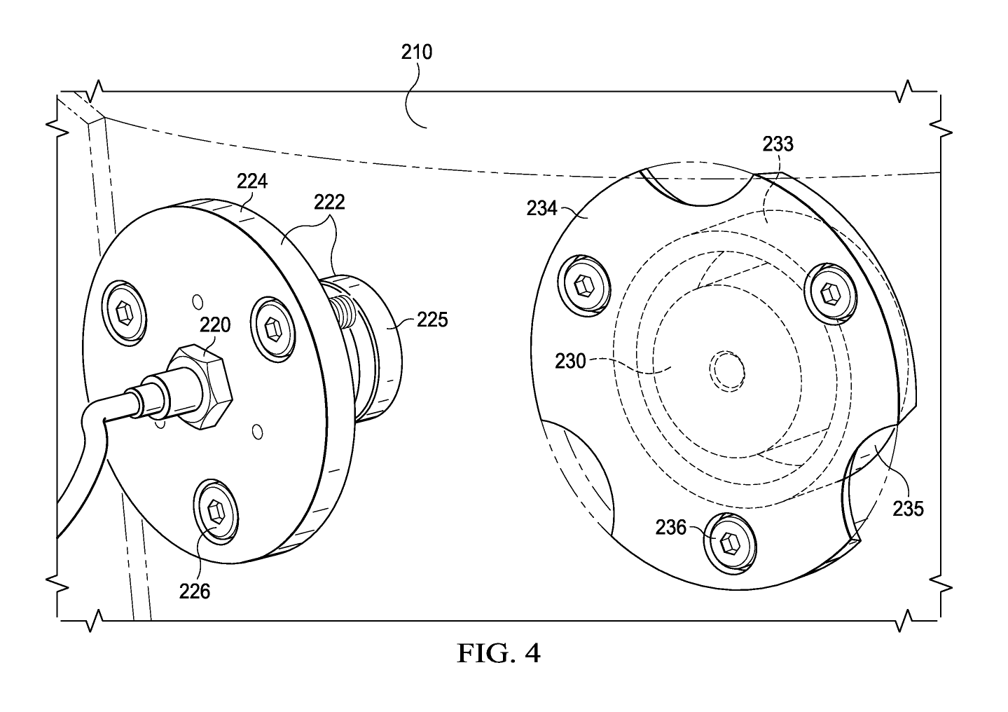

FIG. 4 shows a perspective view of a portion of the rotating control device 200 that includes the sensor 220 and emitter 230. The outer stationary component 201, or pressure shell, has been suppressed to provide a clearer view of the cap 233 and emitter 230 that is better suited for describing the operation of the disclosed assembly. In operation, a drill string or other work string positioned within the upper stripper 211 may rotate, resulting in rotation of the upper stripper 211. The sensor 220 may be used to count the number of rotations of the upper stripper 211 by counting the number of times the emitter 230 passes in front of sensor 220. The count may be incremented each time the sensor 220 detects the signal generated by the emitter 230.

To facilitate this measurement, the emitter 230 passes close enough to the sensor 220 such that signal field of the emitter 230 emanates over and is detected by the sensor 220. The sensor cap 222 and cap 233 may thereby assist with the operation of the rotating control device 200 by (1) not interfering with the signal field generated by the emitter 230, and (2), isolating the emitter 230 from fluid and debris that may degrade the transmitting properties of the emitter 230. The sensor 220 may thereby be used to calculate rotations per minute (RPM) and the total number of revolutions of the upper stripper 211. According to other embodiments, the sensor 220 may be used to conduct and determine the pressure, temperature, vibrational analysis, and debris detection. This information may be used to determine the relative health of the rotating control device 200 by comparing the total number of revolutions with the expected lifespan (in terms of total number of revolutions) of the bearing assembly of the rotating control device 200.

It should be apparent from the foregoing that embodiments of an invention having significant advantages have been provided. While the embodiments are shown in only a few forms, the embodiments are not limited but are susceptible to various changes and modifications without departing from the spirit thereof.

For example, in an alternative embodiment, the rotating control device includes an inductive sensor that is operable to detect a rotation of the rotational component without detecting an active emitter. Such an inductive sensor may generate an electromagnetic sensing field that detects the passing of a component or feature that rotates proximate the sensor to increment a rotation count. In such an embodiment, the emitter may be omitted or may be considered to be the feature of the rotational component that is detected by the inductive sensor.

In another embodiment the rotating control device includes either an acoustic sensor or a radar sensor that functions similarly to the inductive sensor. Such sensors may emanate an acoustic or radar signal and detect changes in a reflected signal that can be used to determine and count a rotation of the rotational component. In an embodiment in which the sensor is an acoustic sensor or a radar sensor, an emitter may be included that emits or reflects an acoustic or radar signature for detection, and a sensor cap and emitter cap may be included that is transmissive of an acoustic signal or a radar signal (i.e., an RF signal).

In another embodiment, the locations of the sensor and emitter may be reversed, such that a rotating control device includes an outer stationary component with an integrated emitter and a rotational component includes an integrated sensor. In such an embodiment, the integrated sensor is included within an outer surface of the rotational component that is adjacent to an inner surface of the outer stationary component. Such a sensor may be located in the rotating control device body, the upper stripper, the bearing assembly, and a tool string that passes through the upper stripper.

In another embodiment, a rotating control device may include one or more sensors, each placed in an outer stationary component or a rotational component. In such an embodiment the sensor may be an inductive sensor, an acoustic sensor, or a radar sensor.

What is claimed is:

1. A rotating control device sensor assembly comprising:
an emitter disposed on a rotational component of a rotating control device, wherein the emitter emanates a signal;
a cap coupled to the rotational component and enclosing the emitter, the cap comprising a transmissive material; and
a sensor that detects the signal through the cap as the emitter passes within a proximity of the sensor.

2. The rotating control device sensor assembly of claim 1, wherein the rotating control device further comprises an outer stationary component, wherein the sensor is disposed on the outer stationary component.

3. The rotating control device sensor assembly of claim 2, wherein the outer stationary component is a pressure shell.

4. The rotating control device sensor assembly of claim 1, wherein the cap is disposed within the rotational component to form a volume between the cap and the rotational component, wherein the emitter is enclosed within the volume, and wherein an outward facing surface of the cap is flush with the outer surface of the rotational component.

5. The rotating control device sensor assembly of claim 1, wherein the rotational component comprises an upper stripper, and wherein the emitter is disposed on the upper stripper.

6. The rotating control device sensor assembly of claim 1, wherein the rotational component comprises an inner rotating bearing assembly, and wherein the emitter is disposed on the inner rotating bearing assembly.

7. The rotating control device sensor assembly of claim 1, further comprising:
a plurality of emitters disposed on the rotational component of the rotating control device, wherein each of the plurality of emitters emanates a detectable signal;
a plurality of caps coupled to the rotational component and enclosing the plurality of emitters, each of the plurality of caps comprising the transmissive material; and
a plurality of sensors, each of the plurality of sensors being operable to detect the detectable signal of one of the plurality of emitters.

8. The rotating control device sensor assembly of claim 1, wherein the transmissive material is selected from the group consisting of a nylon polymer, an austenitic alloy, austenitic stainless steel metal, plastic, and a combination thereof.

9. The rotating control device sensor assembly of claim 1, wherein the transmissive material is selected from the group consisting of a magnetically transmissive material, an optically transmissive material, an acoustically transmissive material, and an RF transmissive material.

10. The rotating control device sensor assembly of claim 1, further comprising a sensor cap that encloses the sensor, the sensor cap comprising the transmissive material.

11. A method for operating a rotating control device sensor assembly, the method comprising:
counting a number of revolutions of a rotational component of a rotating control device; and
comparing the number of revolutions to an expected lifespan of the rotational component to determine an expected remaining lifespan of the rotational component to determine the remaining life of the rotational component;
wherein counting the number of revolutions comprises using a sensor to detect an emitter signal from an emitter disposed on a rotational component of the rotating control device, and
wherein the rotating control device sensor assembly includes a cap coupled to the rotational component and enclosing the sensor, the cap comprising a transmissive material.

12. The method of claim 11, wherein the sensor is disposed on an outer stationary component of the rotating control device.

13. The method of claim 11, wherein the emitter signal comprises a magnetic field, the sensor comprises a magnetic sensor, and the cap comprises a magnetically transmissive material.

14. The method of claim 11, wherein the emitter signal comprises a reflected signal, the sensor comprises a radar sensor, and the cap comprises an RF transmissive material.

15. The method of claim 11, wherein the rotational component comprises an inner rotating bearing assembly.

16. The method of claim 11, wherein the rotating control device sensor assembly comprises an outer stationary component and a sensor cap coupled thereto to enclose the sensor, the sensor cap comprising the transmissive material.

17. A rotating control device emitter cap comprising:
a mating flange, an approximately cylindrical body, and a cavity formed within the approximately cylindrical body;
wherein the cavity forms an enclosure for receiving an emitter; and
wherein the emitter cap comprises a transmissive material.

18. The rotating control device emitter cap of claim 17, wherein the transmissive material is a paramagnetic material.

19. The rotating control device emitter cap of claim 18, wherein the paramagnetic material is selected from the group consisting of a nylon polymer, an austenitic nickel-chromium based super alloy, austenitic stainless steel, plastic, and a combination thereof.

20. The rotating control device emitter cap of claim 17, wherein the transmissive material comprises an RF transmissive material.
